(19) United States
(12) Patent Application Publication
(10) Pub. No.: US 2024/0310163 A1
(43) Pub. Date: Sep. 19, 2024

(54) LINE SPECTRAL CONFOCAL THREE-DIMENSIONAL MEASUREMENT SYSTEM AND METHOD USING LINEAR VARIABLE FILTER

(71) Applicant: SOOCHOW UNIVERSITY, Suzhou City (CN)

(72) Inventors: Xinhua CHEN, Suzhou City (CN); Shiyu GE, Suzhou City (CN); Weimin SHEN, Suzhou City (CN)

(73) Assignee: SOOCHOW UNIVERSITY, Suzhou City (CN)

(21) Appl. No.: 18/413,562

(22) Filed: Jan. 16, 2024

(30) Foreign Application Priority Data
Mar. 17, 2023 (CN) 202310263009.0

(51) Int. Cl. G01B 11/24

(52) U.S. Cl. CPC G01B 11/24

(57) ABSTRACT

Disclosed is a line spectral confocal three-dimensional measurement system and method using a linear variable filter. The system includes a light source module for providing light radiation, a spectral confocal module, and a signal acquisition module. The spectral confocal module includes a first linear variable filter, a first imaging lens group, a second imaging lens group, and a second linear variable filter. The first linear variable filter is configured to separate the light radiation according to different wavelengths. The first imaging lens group is configured to focus the light radiation with different wavelengths at different heights along a normal line of a surface of a measured object. The second imaging lens group is configured to guide the focused light radiation to the second linear variable filter, and the light radiation at a corresponding position of the first linear variable filter passes through the second linear variable filter.

### CROSS-REFERENCE TO RELATED APPLICATION

This patent application claims the benefit and priority of Chinese Patent Application No. 202310263009.0, filed with the China National Intellectual Property Administration on Mar. 17, 2023, the disclosure of which is incorporated by reference herein in its entirety as part of the present application.

### TECHNICAL FIELD

The present disclosure relates to the technical field of optical measurement, and in particular to a line spectral confocal three-dimensional measurement system and method using a linear variable filter.

### BACKGROUND

With the continuous development of science and technology in the society nowadays, higher requirements are put forward for measurement technology. Higher measurement accuracy, larger measurement range and faster measurement speed are required whether in manufacturing or in scientific research.

Commonly used optical measurement technologies include laser triangulation, white light interferometry, laser confocal scanning and so on. However, these methods usually require scanning, leading to prolonged measurement time and decreased measurement efficiency. Meanwhile, the motion accuracy of axial moving elements also limits the measurement accuracy. Spectral confocal technology, as a non-contact measurement technology, is a combination of laser confocal technology and spectral dispersion technology. It avoids the axial scanning process of traditional laser confocal technology while combining the confocal optical path to achieve high signal-to-noise ratio and axial tomography ability, thus greatly improving the measurement speed. In the traditional point spectral confocal system, dispersive lens group is used to achieve spectral separation, which is limited by axial dispersion, and it has a small measurement range. Moreover, the height information of only one point can be obtained by each single measurement, and the three-dimensional measurement of the measured surface can be achieved only by cooperating with the two-dimensional scanning movement, and the measurement efficiency is low due to the influence of the accuracy of the scanning instrument. The current line spectral confocal system mostly adopts prism beam splitting or grating beam splitting. When the prism is used as the beam splitting element, the system is bulky and heavy, and it will generate spectral distortion that cannot be eliminated, and the distortion will get worse rapidly with the increase of the field of view. When the grating is used as the beam splitting element, the manufacturing cost of the system is high, and the multi-stage diffraction of the grating will cause the dispersion to be greatly affected by stray light, leading to the reduction of the utilization rate of light energy.

Therefore, there is an urgent need for innovative line spectral confocal three-dimension measurement system to overcome the above technical defects in the prior art.

### SUMMARY

The technical problem to be solved by the present disclosure is to overcome the technical defects in the prior art. A line spectral confocal three-dimensional measurement system and method using a linear variable filter are provided to address this problem. According to the present disclosure, depth information within a line field of view can also be obtained simultaneously. Continuous and high-speed three-dimensional measurement can be achieved by means of one-dimensional scanning, and thus high precision and high efficiency can be achieved.

In order to solve the technical problem above, a line spectral confocal three-dimensional measurement system using a linear variable filter includes:
a light source module, configured to provide light radiation;
a spectral confocal module, including a first linear variable filter, a first imaging lens group, a second imaging lens group, and a second linear variable filter, where the first linear variable filter is used to receive the light radiation from the light source module, and to separate the light radiation according to different wavelengths; the first imaging lens group is used to guide the light radiation passing through the first linear variable filter to the surface of a measured object, and to focus the light radiation with different wavelengths at different heights along a normal line of the surface of the measured object, thus forming a focal plane; the second imaging lens group is used to guide the light radiation focused on the surface of the measured object to the second linear variable filter in a specular reflection direction; and the second linear variable filter is configured to enable the light radiation at a position, corresponding to the first linear variable filter, of the second linear variable filter to pass through; and
a signal acquisition module, configured to receive the light radiation passing through the second linear variable filter, and to obtain height information of the surface of the measured object according to the light radiation.

In one embodiment of the present disclosure, the first linear variable filter and the second linear variable filter have the same structure, and the first linear variable filter and the second linear variable filter are symmetrically arranged about the focal plane.

In one embodiment of the present disclosure, the first imaging lens group and the second imaging lens group have the same structure, and the first imaging lens group and the second imaging lens group are symmetrically arranged about the focal plane.

In one embodiment of the present disclosure, the first linear variable filter, the first imaging lens group and the focal plane are inclined to one another, thus satisfying Scheimpflug imaging conditions.

In one embodiment of the present disclosure, the second imaging lens group, the second linear variable filter and the focal plane are inclined to one another, thus satisfying the Scheimpflug imaging conditions.

In one embodiment of the present disclosure, the signal acquisition module includes a third imaging lens group and an area detector which are arranged on a reflection light path of the second imaging lens group. The third imaging lens group is configured to guide light transmitting through the second linear variable filter to the area detector, and the area detector is configured to receive a spectral signal.

In one embodiment of the present disclosure, the second linear variable filter, the third imaging lens group and the area detector are inclined to one another, thus satisfying the Scheimpflug imaging conditions.

In one embodiment of the present disclosure, the light source module comprises a light source, and an illuminating system. The light source is configured to provide light radiation, and the illuminating system is configured to output received light radiation into uniform light radiation.

In addition, a line spectral confocal three-dimensional measurement method using a linear variable filter is further provided, including the following steps:
providing light radiation;
receiving, by a first linear variable filter, the light radiation, and separating the light radiation according to different wavelengths;
guiding the light radiation with different wavelengths to a surface of a measured object, focusing the light radiation with different wavelengths at different heights along a normal line of the surface of the measured object, so as to form a focal plane;
guiding the light radiation focused on the surface of the measured object to a second linear variable filter in a specular reflection direction, enabling the light radiation at a position, corresponding to the first linear variable filter, of the second linear variable filter to pass through; and

receiving the light radiation passing through the second linear variable filter, and obtaining height information of the surface of the measured object according to the light radiation.

In one embodiment of the present disclosure, light which fails to focus on the normal line of the surface of the measured object cannot reach the second linear variable filter at a corresponding position of the first linear variable filter.

The technical solution of the present disclosure has the following benefits:

According to a line spectral confocal three-dimensional measurement system and method using a linear variable filter, depth information within a line field of view can be obtained simultaneously, continuous and high-speed three-dimensional measurement can be achieved by means of one-dimensional scanning, and the characteristics of high precision and high efficiency are achieved.

According to the line spectral confocal three-dimensional measurement system and method using the linear variable filter disclosed by the present disclosure, the linear variable filter is used for spectrum separation, which can achieve larger axial measurement range and better linearity. Meanwhile, the structure is simpler, the cost is lower, and the practical use requirements of small volume, large range and small distortion can be satisfied.

According to the line spectral confocal three-dimensional measurement system and method using the linear variable filter disclosed by the present disclosure, an adopted biaxial structure has higher axial resolution compared with a uni-axial structure, and the separation of an illuminating system and a receiving system can effectively improve the energy utilization rate and suppress stray light.

### BRIEF DESCRIPTION OF THE DRAWINGS

In order to make the contents of the present disclosure more clearly understood, the present disclosure will be further described in detail below according to specific embodiments of the present disclosure and with the accompanying drawings.

FIG. 1 is a structural schematic diagram of a line spectral confocal three-dimensional measurement system using a linear variable filter provided by an embodiment 1 of the present disclosure.

In the drawings: 11—light source; 12—illuminating system; 21—first linear variable filter; 22—first imaging lens group; 23—second imaging lens group; 24—second linear variable filter; 31—third imaging lens group; 32—area detector.

### DETAILED DESCRIPTION OF THE EMBODIMENTS

The present disclosure is further described below with reference to the accompanying drawings and specific embodiments, such that those skilled in the art better understand and implement the present disclosure. However, the embodiments given are not intended to limit the present disclosure.

### Embodiment 1

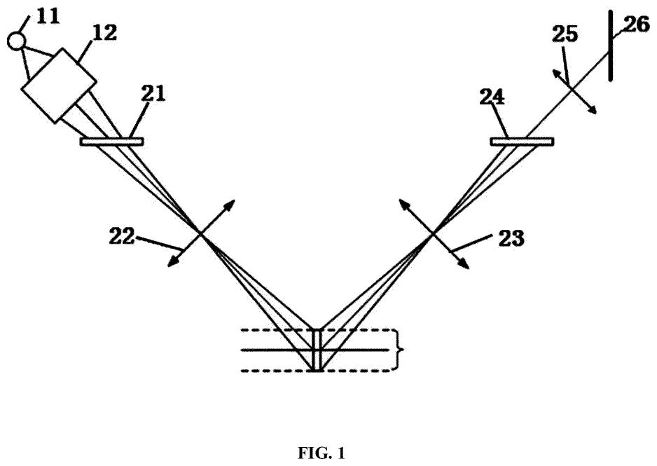

As shown in FIG. 1, a line spectral confocal three-dimensional measurement system using a linear variable filter is provided according to Embodiment 1 of the present disclosure, including a light source, a spectral confocal module, and a signal acquisition module. The light module is configured to provide light radiation. The spectral confocal module includes a first linear variable filter 21, a first imaging lens group 22, a second imaging lens group 23, and a second linear variable filter 24. The first linear variable filter 21 is configured to receive the light radiation from the light source module, and to separate the light radiation according to different wavelengths. The first imaging lens group 22 is used to guide the light radiation through the first linear variable filter 21 to a surface of a measured object, and to focus the light radiation with different wavelengths at different heights along a normal line of the surface of the measured object, thus forming a focal plane. The second imaging lens group 23 is used to guide the light radiation focused on the surface of the measured object to the second linear variable filter 24 in a specular reflection direction. The second linear variable filter 24 is configured to enable the light radiation at a position, corresponding to the first linear variable filter 21, of the second linear variable filter 24 to pass through. The signal acquisition module is configured to receive the light radiation passing through the second linear variable filter 24, and to obtain height information of the surface of the measured object according to the light radiation.

According to a line spectral confocal three-dimensional measurement system using a linear variable filter, depth information within a line field of view can be obtained simultaneously, continuous and high-speed three-dimensional measurement can be achieved by means of one-dimensional scanning, and the characteristics of high precision and high efficiency are achieved.

The light source module includes a light source 11, and an illuminating system 12. The light source 11 is configured to provide light radiation, and the illuminating system 12 is configured to output received light radiation into uniform light radiation. Preferably, a white light source is employed as the light source 11, which has a high light radiation flux in the wave band from 450 nm to 700 nm, so as to provide illumination in the visible range. A Kohler illumination system is used as the illuminating system 12, which improves the uniformity while ensuring the illumination intensity.

The spectral confocal module may be divided into two portions: an emitting end and a receiving end, both of which include a linear variable filter and an imaging lens group, i.e., a first linear variable filter 21 and a first imaging lens group 22 of the emitting end, and a second linear variable filter 24 and a second imaging lens group 23 of the receiving end. The first linear variable filter 21 and the second linear variable filter 24 have the same structure, and the first linear variable filter 21 and the second linear variable filter 24 have the same structure are symmetrically arranged about the confocal plane. Similarly, the first imaging lens group 22 and the second imaging lens group 23 have the same structure, and the first imaging lens group 22 and the second imaging lens group 23 are symmetrically arranged about the confocal plane.

Light emitted from the light source 11 irradiates on the first linear variable filter 21, the light with different wavelengths transmits different positions of the first linear variable filter 21, and after passing through the first imaging lens group 22, the light with different wavelengths is focused at different heights along a normal line of the surface of the measured object, so as to form a focal plane in a direction perpendicular to the measured surface. Only the light focused on the normal line of the surface of the measured object can be perfectly focused, and after being reflected by the surface of the measured object, the focused light passes through the second imaging lens group 23 in a specular reflection direction to reach a position, corresponding to the first linear variable filter 21, of the second linear variable filter 24, and finally enters the subsequent signal acquisition module with greater transmittance. However, the light that fails to focus on the normal line of the surface of the measured object cannot reach the position, corresponding to the first linear variable filter 21, of the second linear variable filter 24 to be filtered by the filter, and thus cannot enter the subsequent signal acquisition module.

The first linear variable filter 21, the first imaging lens group 22 and the focal plane are inclined to one another, and the second linear variable filter 24, the second imaging lens group 23 and the focal plane are inclined to one another, all of which satisfy the Scheimpflug imaging conditions.

According to the line spectral confocal three-dimensional measurement system using the linear variable filter disclosed by the present disclosure, the linear variable filter is used for spectrum separation, which can achieve larger axial measurement range and better linearity. Meanwhile, the structure is simpler, the cost is lower, and the practical use requirements of small volume, large range and small distortion can be satisfied.

The signal acquisition module includes a third imaging lens group 31, and an area detector 32. The third imaging lens group 31 and the area detector 32 are sequentially arranged on a reflection light path of the second imaging lens group 23. The light radiation passing through the second linear variable filter 24 reaches the area detector 32 via the third imaging lens group 31, and the area detector 32 is configured to receive a spectral signal, and then the height information of the surface of the measured object can be obtained by processing the spectral signal.

The second linear variable filter 24, the third imaging lens group 31 and the area detector 32 are inclined to one another, thus satisfying the Scheimpflug imaging conditions.

According to the line spectral confocal three-dimensional measurement system using the linear variable filter disclosed by the present disclosure, an adopted biaxial structure has higher axial resolution compared with a uni-axial structure, and the separation of an illuminating system and a receiving system can effectively improve the energy utilization rate and suppress stray light.

A line spectral confocal three-dimensional measurement method using a linear variable filter disclosed in Embodiment 2 of the present disclosure is introduced below. The line spectral confocal three-dimensional measurement method using the linear variable filter described below and the line spectral confocal three-dimensional measurement system using the linear variable filter described above can refer to each other correspondingly.

### Embodiment 2

In addition, a line spectral confocal three-dimensional measurement method using a linear variable filter is further provided, including the following steps:

Light radiation is provided.

A first linear variable filter 21 is configured to receive light radiation, and to separate the light radiation according to different wavelengths.

The light radiation with different wavelengths is guided to a surface of a measured object, the light radiation with different wavelengths is focused at different heights along a normal line of the surface of the measured object, so as to form a focal plane.

The light radiation focused on the surface of the measured object is guided to a second linear variable filter 24, thus enabling the light radiation at a position, corresponding to the first linear variable filter 21, of the second linear variable filter 4 to pass through.

The light radiation passing through the second linear variable filter is received, and height information of the surface of the measured object is obtained according to the light radiation.

Light emitted from the light source 11 irradiates on the first linear variable filter 21, the light with different wavelengths transmits different positions of the first linear variable filter 21, and after passing through the first imaging lens group 22, the light with different wavelengths is focused at different heights along a normal line of the surface of the measured object, so as to form a focal plane in a direction perpendicular to the measured surface. Only the light focused on the normal line of the surface of the measured object can be perfectly focused, and after being reflected by the surface of the measured object, the focused light passes through the second imaging lens group 23 in a specular reflection direction to reach a position, corresponding to the first linear variable filter 21, of the second linear variable filter 24, and enters the subsequent signal acquisition module with greater transmittance. However, the light that fails to focus on the normal line of the surface of the measured object cannot reach the position, corresponding to the first linear variable filter 21, of the second linear variable filter 24 to be filtered by the filter, and thus cannot enter the subsequent signal acquisition module.

The line spectral confocal three-dimensional measurement method using the linear variable filter of this embodiment is achieved based on the line spectral confocal three-dimensional measurement system using the linear variable filter, so the specific embodiment of the method can be seen in the embodiment part of the line spectral confocal three-dimensional measurement system using the linear variable filter. Therefore, the specific embodiment can refer to the descriptions of the corresponding embodiments, and will not be introduced here.

Since the line spectral confocal three-dimensional measurement method using the linear variable filter in this embodiment is achieved based on the above line spectral confocal three-dimensional measurement system using the linear variable filter, its function corresponds to that of the above system, and thus, it will not be described in detail here.

Apparently, the above embodiments are only examples for clearer explanation, and they are not intended to limit the embodiments. Other variations or modifications in various forms may be made by those skilled in the art in light of the above description. There is no need and no way to exhaust all of the embodiments. Obvious variations or modifications resulting therefrom are still within the scope of aspects of the present disclosure.

1-10. (canceled)

11. A line spectral confocal three-dimensional measurement system using a linear variable filter, comprising:
a light source module, configured to provide light radiation;
a spectral confocal module, comprising a first linear variable filter, a first imaging lens group, a second imaging lens group, and a second linear variable filter, wherein the first linear variable filter is used to receive the light radiation from the light source module, and to separate the light radiation according to different wavelengths; the first imaging lens group is used to guide the light radiation passing through the first linear variable filter to a surface of a measured object, and to focus the light radiation with different wavelengths at different heights along a normal line of the surface of the measured object, thus forming a focal plane; the second imaging lens group is used to guide the light radiation focused on the surface of the measured object to the second linear variable filter in a specular reflection direction; and the second linear variable filter is configured to enable the light radiation at a position, corresponding to the first linear variable filter, of the second linear variable filter to pass through; and
a signal acquisition module, configured to receive the light radiation passing through the second linear variable filter, and to obtain height information of the surface of the measured object according to the light radiation.

12. The line spectral confocal three-dimensional measurement system using a linear variable filter according to claim 11, wherein the first linear variable filter and the second linear variable filter have the same structure, and the first linear variable filter and the second linear variable filter are symmetrically arranged about the focal plane.

13. The line spectral confocal three-dimensional measurement system using a linear variable filter according to claim 11, wherein the first imaging lens group and the second imaging lens group have the same structure, and the first imaging lens group and the second imaging lens group are symmetrically arranged about the focal plane.

14. The line spectral confocal three-dimensional measurement system using a linear variable filter according to claim 12, wherein the first imaging lens group and the second imaging lens group have the same structure, and the first imaging lens group and the second imaging lens group are symmetrically arranged about the focal plane.

15. The line spectral confocal three-dimensional measurement system using a linear variable filter according to claim 13, wherein the first linear variable filter, the first imaging lens group and the focal plane are inclined to one another, thus satisfying Scheimpflug imaging conditions.

16. The line spectral confocal three-dimensional measurement system using a linear variable filter according to claim 14, wherein the first linear variable filter, the first imaging lens group and the focal plane are inclined to one another, thus satisfying Scheimpflug imaging conditions.

17. The line spectral confocal three-dimensional measurement system using a linear variable filter according to claim 13, wherein the second imaging lens group, the second linear variable filter and the focal plane are inclined to one another, thus satisfying the Scheimpflug imaging conditions.

18. The line spectral confocal three-dimensional measurement system using a linear variable filter according to claim 14, wherein the second imaging lens group, the second linear variable filter and the focal plane are inclined to one another, thus satisfying the Scheimpflug imaging conditions.

19. The line spectral confocal three-dimensional measurement system using a linear variable filter according to claim 11, wherein the signal acquisition module comprises a third imaging lens group and an area detector which are arranged on a reflection light path of the second imaging lens group; and the third imaging lens group is configured to guide light transmitting through the second linear variable filter to the area detector, and the area detector is configured to receive a spectral signal.

20. The line spectral confocal three-dimensional measurement system using a linear variable filter according to claim 12, wherein the signal acquisition module comprises a third imaging lens group and an area detector which are arranged on a reflection light path of the second imaging lens group; and the third imaging lens group is configured to guide light transmitting through the second linear variable filter to the area detector, and the area detector is configured to receive a spectral signal.

21. The line spectral confocal three-dimensional measurement system using a linear variable filter according to claim 19, wherein the second linear variable filter, the third imaging lens group and the area detector are inclined to one another, thus satisfying the Scheimpflug imaging conditions.

22. The line spectral confocal three-dimensional measurement system using a linear variable filter according to claim 20, wherein the second linear variable filter, the third imaging lens group and the area detector are inclined to one another, thus satisfying the Scheimpflug imaging conditions.

23. The line spectral confocal three-dimensional measurement system using a linear variable filter according to claim 11, wherein the light source module comprises a light source, and an illuminating system, the light source is configured to provide light radiation, and the illuminating system is configured to output received light radiation into uniform light radiation.

24. The line spectral confocal three-dimensional measurement system using a linear variable filter according to claim 12, wherein the light source module comprises a light source, and an illuminating system, the light source is configured to provide light radiation, and the illuminating system is configured to output received light radiation into uniform light radiation.

25. A line spectral confocal three-dimensional measurement method using a linear variable filter, comprising the following steps:
providing light radiation;
receiving the light radiation by a first linear variable filter, and separating the light radiation according to the wavelengths;
guiding the light radiation with different wavelengths to a surface of a measured object, focusing the light radiation with different wavelengths at different heights along a normal line of the surface of the measured object, so as to form a focal plane;
guiding the light radiation focused on the surface of the measured object to a second linear variable filter in a specular reflection direction, enabling the light radiation at a position, corresponding to the first linear variable filter, of the second linear variable filter to pass through; and
receiving the light radiation passing through the second linear variable filter, and obtaining height information of the surface of the measured object according to the light radiation.

26. The line spectral confocal three-dimensional measurement method using a linear variable filter according to claim 25, wherein light which fails to focus on the normal line of the surface of the measured object is unable to reach the second linear variable filter at a corresponding position of the first linear variable filter.
